(19) United States
(12) Patent Application Publication
(10) Pub. No.: US 2021/0272128 A1
(43) Pub. Date: Sep. 2, 2021

(54) CONTEXTUAL USER INTERFACE INTERACTION LOGGING AND ANALYSIS

(71) Applicant: Wells Fargo Bank, N.A., San Francisco, CA (US)

(72) Inventors: Darrell Todd Slawson, St. Louis, MO (US); Scott Welz, Kirkwood, MO (US)

(21) Appl. No.: 15/251,566

(22) Filed: Aug. 30, 2016

(51) Int. Cl. G06Q 30/00; G06F 17/24; G06F 17/27; G06Q 40/02

(52) U.S. Cl. CPC G06Q 30/01; G06F 17/241; G06F 3/0481; G06F 17/2785; G06Q 40/02; G06F 17/271

(57) ABSTRACT

A method and system are disclosed for processing textual data from a client interaction, implemented with electronic operations for the processing of textual data input. In an example, the free form textual data input indicates details of an interaction between a human advisor and a human client, with the free form text being entered by the human advisor in response to the interaction. The processing operations may include parsing the textual data to identify a semantic concept expressed in the textual data, associating the textual data with a tag based on the semantic concept, and identifying a subsequent action to be performed by the human advisor based on the tag. Further operations may include outputting an indication that is related to the subsequent action to be performed, such as to allow scheduling and follow-up with the subsequent action, and collecting feedback from the performance of the subsequent action.

### TECHNICAL HELD

Embodiments described herein generally relate to electronic processing activities occurring in the design, generation, processing, and output of user interface platforms, and in particular, but not by way of limitation, to a system and method for capturing details of interactions and performing analysis on such interactions.

### BACKGROUND

A variety of interactions may occur in communication sessions between humans, particularly in the client-service provider setting where the service provider communicates with a client about professional services (e.g., for financial, legal, medical consultations). Such interactions may involve in-person meetings, phone or audio conversations, exchanged email or text messages, online chat sessions, and the like. During such interactions, a service provider representative may resort to taking notes (e.g., written by hand or manually typed out) to capture details of the interaction with the client customer, and to note follow up tasks, recommendations, and activities.

Some electronic customer relationship management (CRM) systems are designed to display information for a particular customer, and such CRM systems may include a transaction or interaction log with data spaces where a service provider representative can enter notes on a particular customer. However, the entry and review of these notes in a CRM system is often a manual process, requiring a human to manually review and analyze text, and understand the context in which the notes were captured. This may be problematic if the notes were written in an unclear manner, or if the author of the notes has some specialized knowledge of the customer that is not indicated in the notes. As a result, many service provider/client interactions are not fully logged, and useful information or activities may become lost or obscured.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram of an electronic communication environment depicting operations and interactions with a dynamic interaction processing system, according to various examples;

FIG. 2 is a diagram depicting data activities occurring among data analysis, data management, and data feedback operations in a dynamic interaction processing system, according to various examples;

FIGS. 3A to 3D illustrate respective graphical user interface layouts for capturing and processing text using a dynamic interaction processing system, according to various examples;

FIG. 4 illustrates a graphical user interface layout for outputting automatically generated action recommendations using a dynamic interaction processing system, according to various examples;

FIG. 5 illustrates a further graphical user interface layout for capturing and processing text using a dynamic interaction processing system, based on automatically-generated content recommendations, according to various examples;

FIG. 6 is a flowchart of an example sequence of operations for analyzing and tagging unstructured text content within a dynamic interaction processing system, according to various examples;

FIG. 7 is a flowchart of an example method of use for processing textual data from a client interaction using a dynamic interaction processing system, according to various examples;

FIG. 8 is a block diagram of a machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

In various examples described herein, a dynamic interaction processing framework is provided to capture details from service provider advisor interactions with clients, from real-world interactions such as meetings, phone calls, etc., and the items discussed in such interactions. The dynamic interaction processing framework operates to analyze the content of these notes and identifies actions, alerts, follow ups, etc., and establish and manage workflow activities. Accompanying processing methods used with the dynamic interaction processing framework may generate opportunities for an advisor to provide feedback on the quality of the automated action items, and for supervision functions to allow a supervisor or company to track and monitor quality and performance of a particular advisor (or series of interactions with a customer or set of customers).

In an example, the dynamic interaction processing framework may include a data management component, a data analysis component, and a data feedback component. For example, the data management component may manage a client interaction database that captures free form input (e.g., free form text) regarding client interactions. The data entries may be tagged, categorized, or otherwise annotated for later analysis and reporting. The data analysis component may include an automatic tool that reviews the contents of the client interaction database and identifies potential action items based on a set of baseline rules or best practices from these interactions. Actions could enable activities such as: interaction follow-ups (e.g., providing or requesting additional documentation to a customer), portfolio recommendations, product recommendations, or items to alert on. The data feedback component may include an interface for an advisor to evaluate the applicability or value of the automated action item so that the system can improve future recommendations in general, and so that the framework can create customized recommendations for specific clients.

The automatic management of the workflow activities may include defining or assigning an activity to an accountable person, establishing due dates, completion tracking, and other features to assist an electronically-tracked workflow resulting from the interaction. Further, the operation of the data analysis component may automatically identify action items from a basic rule set, and generate individual action plans (i.e., at a client level) based on the rule set. The data analysis component may also integrate with supervision and monitoring components, to allow a business to identify individual advisor who are performing better with respect to meeting follow-ups, action items, best practices, etc., and to gain an overview of interactions that are occurring among the respective service provider advisors.

Existing techniques for capturing client relationship details often involve many manual activities and human analysis to capture client interactions, and do not offer a mechanism for centralized monitoring, control, or application of rules in an automated fashion (or, in a fashion that clearly aligns with a company's or client's business strategy). Further, given the time-sensitive and fast-paced nature of many interactions, many notes taken from conversation are often unstructured data in free form text with a conversational form, which again requires human analysis to obtain useful data points from such data. The techniques described herein provide techniques to analyze such unstructured data, and correlate useful activities and data values to the characteristics captured in the unstructured data.

As discussed herein, the present systems and techniques are applicable to a variety of clients, and are not limited to the specific client-service provider scenarios discussed herein. Accordingly, the present systems and techniques may be relevant to use in any number of contact management, relationship management, and client experience scenarios. Further, although the present systems and techniques are discussed in the context of capturing notes from client interactions, it will be understood that the techniques may be used for the analysis of any number of information types relating to documentation and events, and accompanying alerts and notifications.

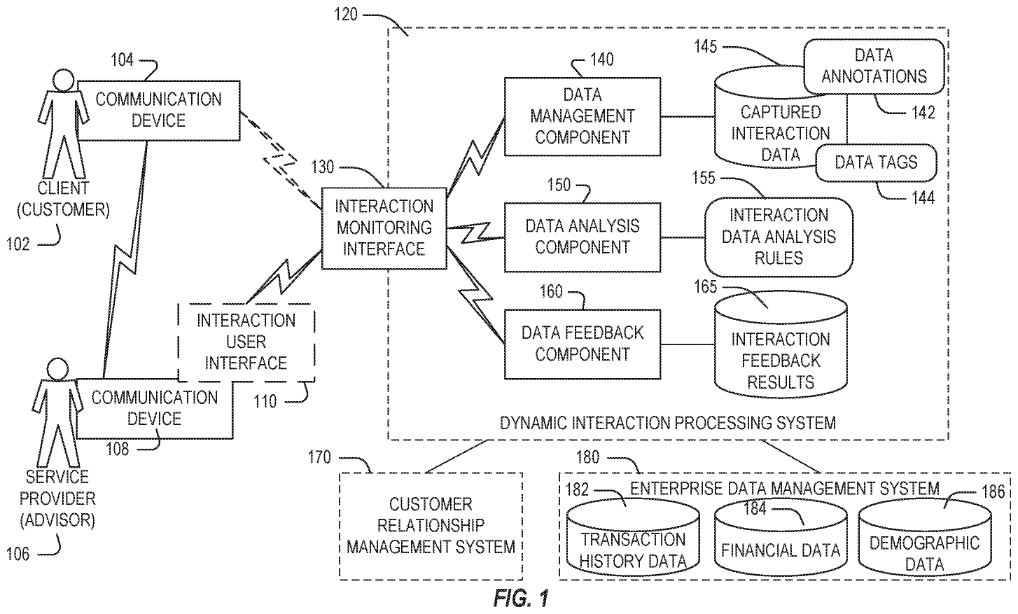

FIG. 1 is a diagram of an electronic communication environment, depicting operations and interactions with a dynamic interaction processing system 120 according to an example. FIG. 1 specifically illustrates a scenario in which a client customer 102 operates a communication device 104 to engage in a communication session with a communication device 108 operated by a service provider advisor 106 (e.g., an agent, employee, consultant, etc.). This communication session may occur via an electronic connection established directly between the client customer 102 and the service provider advisor 106 (e.g., via a phone call between communication devices 104, 108) or established indirectly via another communication system (e.g., via an online chat session in a website). Thus, additional hardware and communication system components may be used for the communication session.

During (or after) the communication session, the service provider advisor 106 operates an interaction user interface 110 to enter various input regarding the communication session. The output provided in the interaction user interface 110 may include a variety of content items for display, including graphics, multimedia content, and other static or dynamically generated output content, including content items to assist the entry of the input. The input received in the interaction user interface 110 includes free form text notes (e.g., observations, comments, recommendations, tasks, instructions) regarding a product or service involving the client or service provider. The interaction user interface 110 communicates interaction data including the free form text notes to an interaction monitoring interface 130, which offers an interface to the dynamic interaction processing system 120. In some examples, the interaction user interface 110 may operate on the communication device 108. Also in some examples, the interaction monitoring interface 130 may collect or receive interaction data directly or indirectly from the client's communicate on device 104.

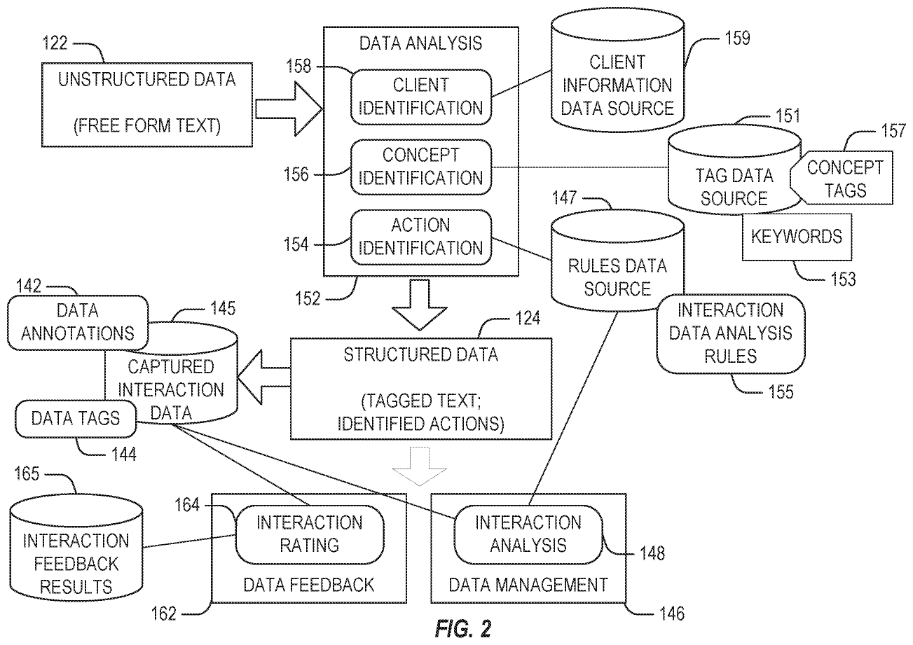

As further shown in FIG. 1, the dynamic interaction processing system 120 includes a series of components that operate to perform management, analysis, and feedback of interaction. These components include a data management component 140 to capture text data in a captured interaction data store 145 and associate such text data with data annotations 142 and data tags 144; a data analysis component 150 to evaluate the text data and determine (and suggest) appropriate further actions and activities based on interaction data analysis rules 155; a data feedback component 160 to record feedback on the further actions and activities in an interaction feedback results data store 165. The data flows involved in operation of these components is further illustrated in FIG. 2 below.

As shown, the data management component 140 is adapted to maintain the captured interaction data store 145, which may store text data in addition to other interaction data fields and details. In addition to text data items, respective interaction sessions or activities may be associated with the data annotations 142 or the data tags 144. The data annotations 142 and the data tags 144 may be associated as a result of manual human activity (e.g., from service provider actions and designation in the interaction user interface 110), or as a result of automated actions (e.g., as a result of data analysis applied by the data analysis component 150 to identify and apply tags).

The data analysis component 150 may operate to suggest various activities related to the product or service, based on the interaction data analysis rules 155. For example, a customer interaction that includes text associated with a financial activity (such as “client wants to start saving for kids' school”) may be first tagged with an “education saving” tag; follow up activities (such as set a reminder to open a specific education investment account in 6 months) can be determined based on a predefined data analysis rule which defines this activity fur this tag. Thus, smart tagging becomes one of the ways that can be used to evaluate conclusions and inferences, and launch associated activities.

The data feedback component 160 may operate to apply user feedback, analysis algorithms, and aspects of dynamic learning (including machine learning techniques) to record responses to tagging and activities. For example, when an advisor is presented with a suggested activity (e.g., an activity that is generated from a particular tag), a series of feedback inputs may be received to determine whether the suggested activity was useful, not useful, should be changed, or should be reclassified. Thus, with operation of the data feedback component 160, the dynamic interaction processing system 120 may implement various learning mechanisms to become “smarter” about the data that it is analyzing and classifying.

In addition to the data interfaces and data stored within the dynamic interaction processing system 120, the dynamic interaction processing system 120 may access data stored in other sources available to the service provider. These data sources may include access and operation of a customer relationship management (CRM) system 170, or an enterprise data management system 180. For example, the dynamic interaction processing system 120 may obtain information from the CRM system 170 when determining automated text suggestions or data tags associated with a particular customer, or to identify available actions that are unique to a particular customer or group of customers. Likewise, information from an enterprise data management system 180 may be used to generate certain types of activities based on promotions, preferences, or campaigns available from the service provider.

In an example, the enterprise data management system may provide one or more data sources that store and maintain customer data relevant to an enterprise business, such as transaction history data 182, financial data 184, and demographic data 186. For example, the transaction history data 182 may include a listing of prior business transactions and transaction information for activities between the enterprise business and the particular customer; the financial data 184 may include a listing of financial transactions and transaction details for financial actions occurring with an account of the particular customer; and the demographic data 186 may include a listing of household relationships, information, or other demographic details for the particular customer.

Continuing an example of dynamically-generated content, FIG. 2 provides a diagram depicting data activities occurring among data analysis, data management, and data feedback operations in a dynamic interaction processing system according to an example. Specifically, FIG. 2 depicts a data flow for implementing data tagging in the dynamic interaction processing system 120, such as may be determined from data analysis functions 152 (e.g., implemented with data analysis component 150), maintained or stored by data management function 146 (e.g., implemented with data management component 140), and rated or evaluated with data feedback functions 162 (e.g., implemented with data feedback component 160).

As shown, unstructured data 122 is received in the form of free form text. Further to the example of FIG. 1, this text may originate from inputs in a contact management system of the service provider that is adapted to capture textual notes from service provider advisor and customer conversations. As a result of the unstructured nature of free form text notes, such content is hard to search or categorize; thus, with prior techniques, a human advisor might review pages of notes in order to determine or locate a concept or action associated with the notes.

The operation of the data analysis functions 152 operate to transform the unstructured data 122 into structured data 124, through the association of client-unique information, tags, and actions to the data content. The data analysis functions 152 operate to categorize the characteristics and attributes that are directly related to a customer (client) account, a conversation, or a situation that are communicated to or observed by an advisor. As a result, the data analysis functions 152 allows free form interaction notes entered by an advisor to be captured and analyzed, while providing structure and rigor to the textual data so that the textual data can be uniformly evaluated, searched, and processed.

As an example of a data analysis function, the client identification function 158 may operate to access a client information data source 159. The data from this data source may be used to narrow the type of concepts (or products and services) that are available in concept identification; the data from this data source may also be used to provide narrowed or customized (e.g., customer-specific or customer-group-specific) recommendations when identifying relevant concepts in textual note content. In an example, the client information data source 159 is provided from data obtained from the enterprise data management system 180 (such as transaction history data 182, the financial data 184, and the demographic data 186).

As another example of a data analysis function, the concept identification function 156 may operate to access a tag data source 151 to identify relevant concepts that are associated with tags. Specifically, such concepts may be associated with concept tags 157 or keywords 153. For example, the concept identification function 156 may apply one or more algorithms to search the text of the unstructured data 122 for certain keywords, phrases, or semantic meaning from the notes. For example, context-specific keywords such as “baby”, “marriage”, “child”, “retirement”, “mortgage”, etc., may be used to trigger notifications. Also for example, other types of natural language processing may be used to identify likely matching concepts, or connections between text and available actions.

As another example of a data analysis function, the action identification function 154 may be used to generate recommended actions, and analyze activity patterns. For example, if a particular client repeatedly shows up in an advisor's notes over some time period (such as a week or month), a follow-up activity, customer care alert, supervisor notification, or the like, can be launched. Likewise, certain types of keywords or concepts that are identified may be flagged for higher-level (e.g., supervisory) review and activities with the action identification function 154.

The action identification function 154 may also apply various data interaction rules for the auto-completion, selection, or suggestion of data fields. For example, if an advisor user types in the term “bank account”, a dropdown or pop-up option may be automatically presented in the user interface to link the note to a certain bank account. The action identification function 154 may identify such actions using a variety of free form analytics (derived from the concept identification function 156), while also looking at key attributes based on the particular customer or customer account (derived from the client identification function 158).

As a result of the data analysis function 152, and any inputs or selections from an advisor user, data is stored in a structured data 124 form. This structured data 124 may be stored in a captured interaction data store 145, with associated data annotations 142 and data tags 144. As is apparent, content that is tagged and annotated may become far easier to search and categorize, or to launch subsequent activities. For example, follow-up tasks may be manually or automatically launched as a result of the data tags 144 and data annotations 142 that are applied to certain notes. Further, the data tags 144 and the data annotations 142 may be directly used by an advisor to identify key pieces of information associated with a customer or some set of data content.

In a further example, the data analysis function 152 and the application of the data annotations 142 and the data tags 144 may occur during input of the unstructured data 122 into a user interface. This may be implemented with the use of a template that suggests content types and content classifications for a user as the user creates or annotates the unstructured data 122. For example, a graphical user interface may offer suggestions of tags or content during the customer session or as the advisor is recording the notes. Such suggestions may be accompanied by the application of best practices, data requirements, data validation, or the like.

The data feedback functions 162 operate upon subsequent uses of data from the captured interaction data store 145. Such feedback may include an interaction rating 164 that is provided from learning the actual click patterns, text entered, the analytics in the technology, and what respective advisors are doing with the structured data 124. The results of the interaction rating 164 and other attributes of interaction feedback may be stored in an interaction feedback results data store 165. In further examples, the data feedback functions 162 may include personalized or unique capabilities for individual advisors to define custom tags, rules, and follow-up activities. For example, an advisor may create a custom tag to launch a particular follow-up activity in response to a certain keyword being used. Such custom tags may be directly associated with keywords entered in the freeform text, and linked to concepts.

Further evaluation of the data may be provided through a data management function 146, including interaction analysis 148 of the original interaction (that provides the unstructured data 122) as well as follow-up activities launched from the action identification functions 154. Such analysis may evaluate how a particular advisor completes tasks or activities in the overall system; how a note is typically created or accessed; and how a customer or groups of customers react to specific activities. The data management function 146 may also provide supervision opportunities for management, such as to ensure that interaction data analysis rules 155 from a rules data source 147 are properly applied during an interaction.

Additionally, tags, signals, and identified concepts from one data source may be used to identify, generate, and trigger actions identified from other data sources. For example, the enterprise data management system 180 and the associated transaction history data 182, the financial data 184, and the demographic data 186 for a particular customer may control actions occurring with the interaction rating 164 or the interaction analysis 148.

Although the data sources depicted in FIG. 2 are illustrated as separate data stores, it will be understood that they may be provided in a centralized database system, and with the combination or establishment of overlapping data structures. Further, the use of the data stores in a separated or centralized configuration may be employed with various data mining technologies, including the use of data mining to expose information patterns and new activities.

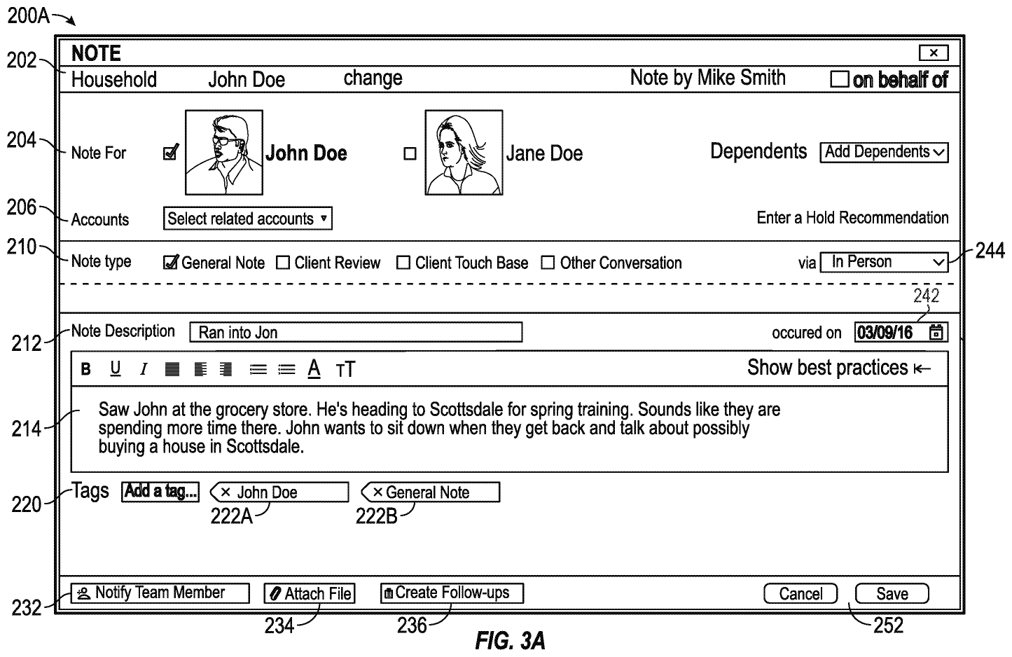

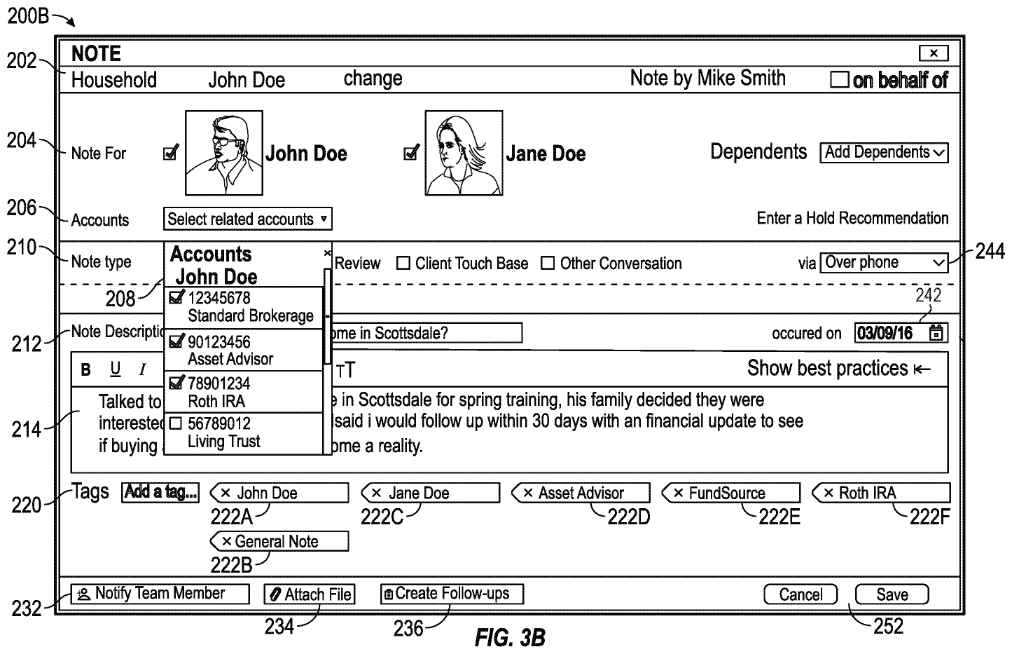

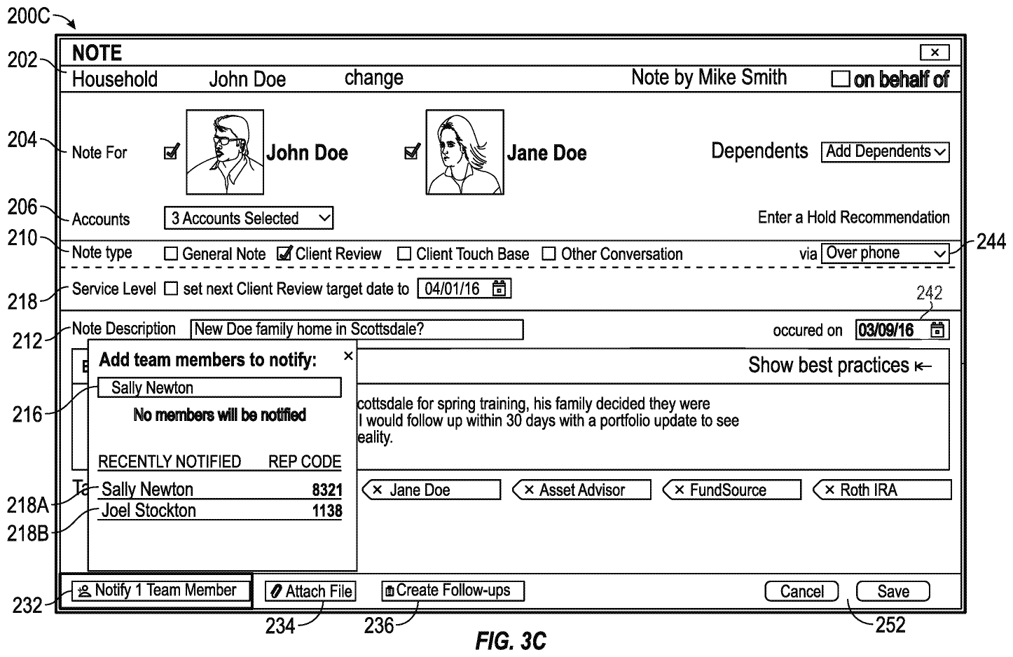

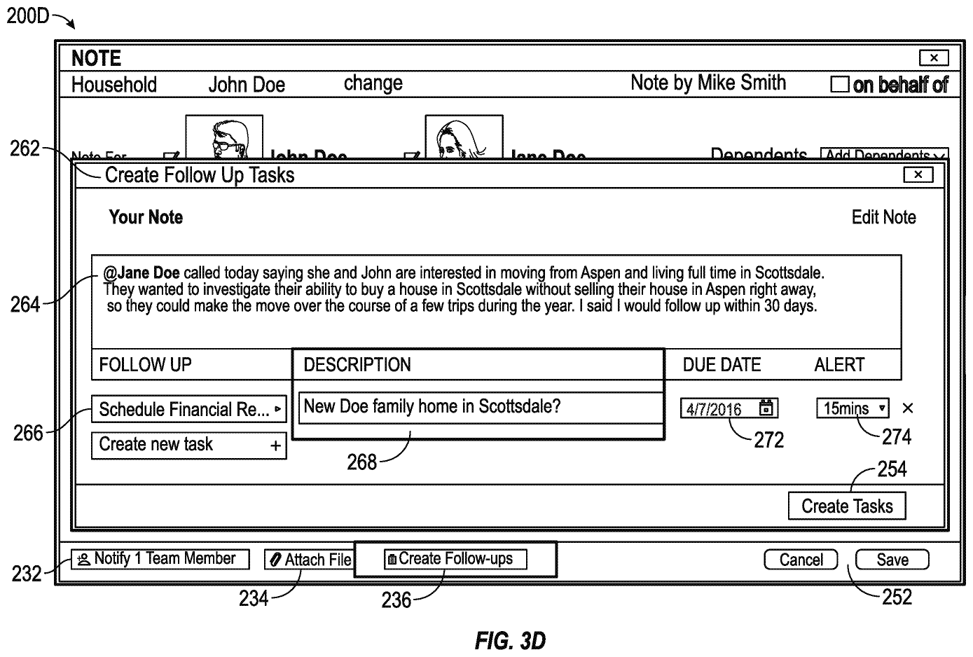

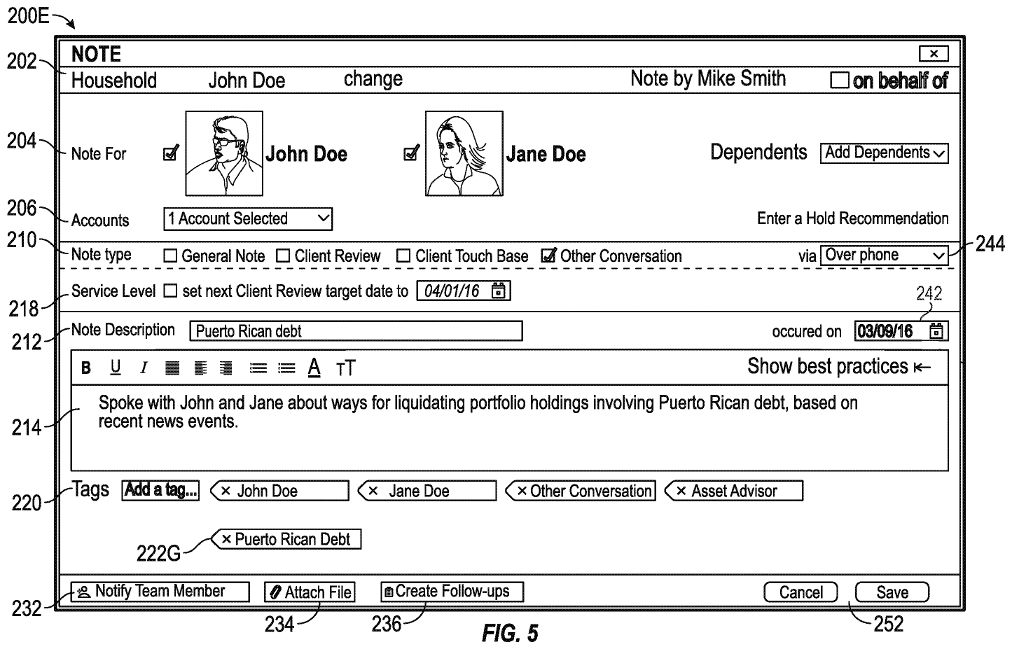

FIG. 3A illustrates an example of a graphical user interface layout for capturing and processing text from a client interaction, according to an example. Specifically, FIG. 3A illustrates a scenario where a service provider advisor has entered unstructured text content into a note field 214 within a note user interface 200A, offered by a graphical user interface of a dynamic interaction processing system. As shown, this note user interface 200A (and the note user interfaces depicted in FIGS. 3A-3D and FIG. 5) each includes a series of text entry features and text entry fields, but it will be understood that other variations of unstructured and structured data entry fields may also be used with the interaction techniques described herein.

In FIG. 3A, the note user interface 200A includes an identification of a customer account 202, a selection field 204 to designate a selection of particular customer of the customer account, and a selection field 206 to designate a selection of a particular account of the customer accounts. The note user interface 200A further includes a selection field 210 to indicate the type of note that is being recorded or entered, and a note description field 212 (which may include unstructured or templated text content). The selection field 210 and the note description field 212 may be used for an initial categorization on which type of tags and classifiers (and suggested actions) are made available.

The note field 214 is depicted as including a narrative of freeform text, here indicating that the customer and service provider advisor had an in-person meeting, regarding certain topics. As a result of the selection of the selection field 204 for the customer and the selection field 210 for the note type, a series of tags (e.g., multiple tags), such as a customer tag 222A and a note type tag 222B may be automatically generated and applied within a tags field 220. The tags field 220 may also allow the application of one or more custom tags, such as tags that are manually selected and entered through a text entry field. The note may be further classified based on a date selection field 242, an interaction type selection field 244.

Based on the text content entered in the note field 214, and the tags identified for the type of note and the text content, various actions may be provided for storage and processing of the note via the note user interface 200A. This may include a selectable notification option 232 to notify a team member or supervisor regarding the note; a selectable attachment option 234 to attach file information or additional content; and a follow-up task option 236 to create a follow-up task associated with the note. Further, processing options 252 to cancel or save the note may also be offered in the note user interface 200A. In an example, in response to selection of the “save” option in the processing options 252, the textual data in the note field 214 is parsed and processed. In another example, the textual data in the note field 214 is parsed as it is entered by the advisor (such as may be entered in a note taking session occurring during the client-advisor meeting).

FIG. 3B illustrates a further example of a graphical user interface layout for capturing and processing text from a further client interaction, according to an example. Specifically, FIG. 3B illustrates a scenario where a service provider advisor has entered additional unstructured text content into the note field 214 within a note user interface 200B offered by a graphical user interface within the dynamic interaction processing system. As shown, this note user interface 200B includes a series of features based on those described in FIG. 3A, but with the entry of other text content for the note, and the selection of multiple accounts and persons.

As shown, in the note user interface 200B, the selection field 206 to designate a selection of a particular account includes an account selection option 208 that allows one or multiple accounts to be associated with the note. As shown, the selection of three of four accounts associated with the customer may be provided with the account selection option 208. Additionally, the selection field 204 for the customer includes the selection of multiple persons that the note is relevant to.

Based on the new content entered in the note field 214, additional tags 222C, 222D, 222E, 222F are automatically identified for association with the text. For example, the additional tag 222C corresponds to the selection of another person; the additional tag 222D corresponds to the involvement of another type of advisor (an asset advisor) to become involved in a future activity; the additional tag 222E identifies a service that may be offered to the customer in a future activity; and the additional tag 222F identifies a product that may be offered to the customer in a future activity.

FIG. 3C illustrates a further example of a graphical user interface layout for capturing and processing text from the client interaction also depicted in FIG. 3B, according to an example. Specifically, FIG. 3C illustrates a scenario where a service provider advisor has designated a notification action for the client interaction, based on the designation of the notification option 232 within a note user interface 200C offered within the dynamic interaction processing system.

As shown, activation of the notification option 232 in the note user interface 200C causes display of a notification selection window 216 for a selection of additional advisors (e.g., managers, co-workers, team members, etc.) to alert regarding the note and any future activity. The notification selection window 216 may include an entry field (e.g., a text box) for the manual entry of an additional advisor; the notification selection window 216 may also include an indication of recommended advisors, such as advisors 218A or 218B (e.g., based on recent activity; based on assignment to the type of product or service; based on the relationship to the client; or based on like factors). The types of available notifications may be established from a service level selection option 218 that can set a future target follow-up date (or customized follow-up activities).

FIG. 3D illustrates a further example of a graphical user interface layout for capturing and processing text from a client interaction, according to an example. Specifically, FIG. 3D illustrates a scenario where a service provider advisor has designated a follow-up task associated with the client interaction, based on the designation of the follow-up task option 236 within a note user interface 200D offered within the dynamic interaction processing system.

As shown, activation of the follow-up task option 236 in the note user interface 200D causes display of a task display window 262 for a selection and designation of subsequent activities associated with the note. The task display window 262 may include an indication of the note text 264 including tags, a selectable input 266 to indicate a type of a follow-up activity, a description field 268 to indicate a text description of the follow-up activity, a date field 272 to indicate a date for performance or reminder for the follow-up activity, and a reminder time indication 274 to establish a reminder to complete, conduct, or provide further details for the follow-up activity. The note user interface 200D further includes a selection option 254 to create the task in response to the advisor approval and revision of the data fields in the task display window 262. However, it will be understood that other features of the follow-up activity and tasks may be automatically scheduled and entered (e.g., based on predefined rules).

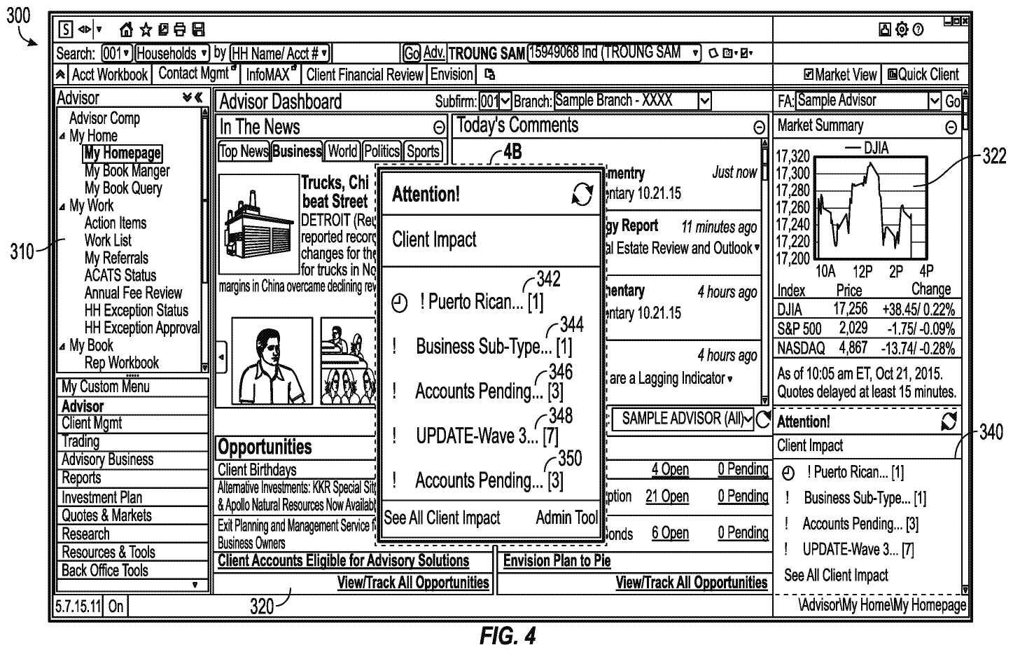

FIG. 4 illustrates a graphical user interface layout for outputting automatically generated action recommendations for use in a dynamic interaction processing system, according to an example. Specifically, FIG. 5 illustrates a graphical user interface 300 providing an output of various content in a dashboard, such as a news content output 320, a financial market content output 322, and an account management navigation output 310, customized with features and functions for a particular advisor. Additionally, the graphical user interface 300 is configured to provide an alert content output 340 based on activities that are generated for the particular advisor with the dynamic interaction processing system.

As shown, the alert content output 340 may include a display of further details and linked activities (e.g., activities 342, 344, 346, 348, 350) for accounts or clients associated with the advisor. Illustrative examples of such alerts may include tasks such as accounts that require follow up activities, such as the entry of updated information, or approval of pending accounts. These follow up activities may be automatically generated or originated from from past interaction activities, such as a past customer interaction to open a new account, a past customer interaction to inquire about a new service or account feature, or the like. Additionally, such alerts may be generated as a result of news events or analysis appearing in the news content output 320 of the graphical user interface 300. For example, a significant change in a financial market that is driven by a news event, may correlate to a change in a product or service that is managed by the advisor. Subsequent customer questions or inquiries related to this product or service (due to the news events) may also trigger further interaction and follow-up activities.

FIG. 5 illustrates a further example of a graphical user interface layout for capturing and processing text for a client interaction, according to an example. Specifically, FIG. 5 illustrates a scenario where a service provider advisor has entered notes from a triggered follow-up interaction with a client, within a note user interface 200E offered within the dynamic interaction processing system, with the follow-up interaction directly associated with the news content output 320 appearing in the graphical user interface 300.

As shown, the note field 214 includes the memorialization of a conversation between the advisor and the customer, which is related to recent news events. In an example, suggested text (such as an agenda) for this interaction may be generated and output in the note field 214. Additionally, the task may be associated with an additional tag 222G that identifies the news event. Thus, with use of the tag, an advisor may easily locate all clients or accounts associated with the news item (and all notes that have been recorded in the past that may involve the news item).

Other variations to the advisor-customer activities and interactions may be recorded with the system and user interfaces described herein. As another example in the context of financial advice, suppose a young couple as client are about to have their first child, and an indication of this upcoming change to the family is recorded by an advisor in a note with a future follow-up date, with the note including a suggested action to add the child as a dependent beneficiary. Later, after the child is born, an automated engine in the background may alert to the advisor to suggested action, and offer a reminder to open a college savings plan. This reminder may pop up as a suggestion when the customer has another interaction and is taking notes with the customer. (As discussed above, the contextual window may include a template to start to show an advisor suggestions and recommendations that are relevant to the characteristics of the customer and the concept being recorded.) This reminder also may occur on a scheduled basis, such as being set as a reminder to follow up with a conversation with the parents and be automatically added on a follow up contact list to discuss this top with the customer. The feedback received for the subsequent interaction with the customer may also be used to customize further interactions with a customer (in this example, the parents of the new child) or a group of customers (for example, all new parents). For example, an advisor can record feedback as being successful or unsuccessful, such as if parents are not typically interested in a college saving product 6 months after the child's birthday, but are more likely to respond to the college saving product one year after the child's birthday.

In further examples, the logic that is applied to analyze the unstructured data may be customized or adaptive to characteristics of a particular advisor or group of advisors, including features for management, supervision, or oversight of such advisors. For example, some recommendations may be offered (or prohibited) by regulation from certain sets of financial advisors. Certain advisors or groups of advisors may also set preferences on which practices work better (or are not permitted). The feedback and management of interactions occurring with the dynamic interaction processing system thus may provide learning and adapting to the particular characteristics of a customer. This can be useful in a team-based approach to implement consistent interaction feedback actions among multiple advisors or groups of a service provider. Further, the use of specific keywords to identify compliance and auditing concepts may also assist operations of service providers with compliance for legal or regulatory requirements.

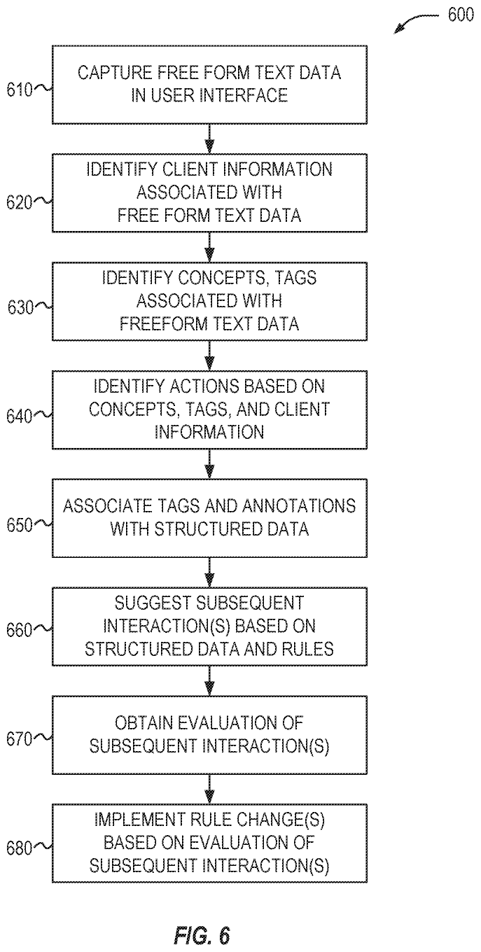

FIG. 6 depicts a flowchart 600 of an example sequence of operations for analyzing and utilizing unstructured text content within a dynamic interaction processing system, according to another example. For example, the operations may be implemented using the dynamic interaction processing system 120 described above with reference to FIG. 1, and described with reference to the data processing activities of FIG. 2; however, it will be understood that other types of systems and example scenarios may implement the following sequence of operations.

The depicted steps of the flowchart 600 include the intake of textual data, such as may be provided with a capture of free form textual data that is entered in a user interface (operation 610). As described above, this textual data may include free form textual notes written in conversational or natural language forms, including in an advisor-controlled graphical user interface that is adapted to capture notes for a particular interaction that occurs with a particular client.

The data analysis functions performed on the text data may include the identification of client information associated with the text data (operation 620), and the identification of concepts and tags associated with the text data (operation 630). The identification of client information associated with the text data may be provided from the selection or identification of a client in a graphical user interface, or from textual content that identifies a particular client or customer directly in the textual content. The identification of the concepts and tags associated with the text data may be provided through natural language processing, keyword searching, and other automated or human-assisted designation of textual words and phrases.

Based on the concepts, tags, and the client information associated with the text data, respective actions may be identified and designated (operation 640). These respective actions may include suggestions offered in real-time, follow-up activities, and subsequent interactions that are scheduled for the customer. The respective actions that are identified may be determined with the application of interaction data analysis rules that suggest or define the timing and content of a future interaction (for example, a rule that establishes a follow-up activity in one month for a particular concept, interaction, or customer).

Additionally, the text data from the interaction may be associated with respective data tags and data annotations (including data tags and annotations corresponding to the identified concepts and actions), and stored in a captured interaction database (operation 650). The storage of this text data may be provided tagged text, and with identified actions, to enable the persistence of structured data.

Further activities in an interaction workflow may be launched based on the structured data. These activities may include the suggestion of one or more subsequent interactions with the client based on the structured data and the interaction rules (operation 660). The subsequent interactions, which may occur electronically or in a real-world, offline setting, will then occur. An evaluation of this subsequent interaction may occur (operation 670), such as by being captured in an interface of a graphical user interface. Based on the evaluation of the subsequent interaction, various rule changes to the interaction data analysis rules may be implemented in the system (operation 680).

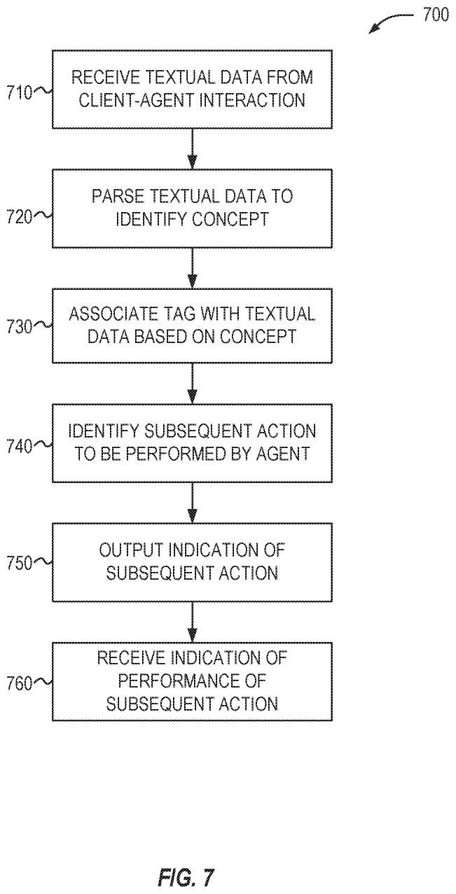

FIG. 7 illustrates a flowchart 700 for a method of processing textual data from a client interaction, performed with electronic operations of a dynamic interaction processing system, according to various examples. The method of the flowchart 700 may be performed by any of the components, logic, or systems described herein. Further, the order and type of the operations depicted in the flowchart 700 may be added, modified, or substituted using any of the operations or functions described above.

In an example, at operation 710, the method begins with the receipt of textual data, such as textual data entered by an advisor (and provided from the client advisor interaction). This textual data may indicate details of an interaction between a human advisor and a human client, such as free form text entered by the human advisor in response to the interaction with the human client.

The method of the flowchart 700 continues with the parsing of the textual data to identify a concept, as shown in operation 720. This parsing may occur during the entry of the textual data in a graphical user interface, or at a subsequent time when the textual data is provided to a processing component In an example, the parsing of the textual data includes identifying client information from the text data, such as which person, account, product, or service that is relevant to the text data. In an example, the parsing of the textual data includes the identification of a particular tag associated with the concept, based on matching of a keyword or semantic concept associated with the tag and with the text data.

The method of the flowchart 700 continues with the associating of the tag with the textual data, as shown in operation 730. This association may be established based on a concept (associated with the tag) that corresponds to a concept expressed in the textual data. This association may be stored or persisted in a database, thus linking various notes and textual data with tags and concepts. This association may also be determined using customer- and business-specific characteristics obtained from an enterprise management data system, such as transaction history data, financial data, or demographic data, of a particular customer or set of customers.

The method of the flowchart 700 continues with the identifying of a subsequent action based on the tag, as shown in operation 740. The subsequent action may be an automatically identified follow-up action, a scheduled action, or like activity that corresponds to the tag. The type and characteristics of the activity may be further defined based on rules and preferences for the service provider, the type of activity, regulatory or legal requirements, the customer-and business-specific characteristics, and the like.

The method of the flowchart 700 continues with the outputting of an indication that corresponds to the subsequent action to be performed, as shown in operation 750. As an example, this may include an indication of a reminder that is scheduled to accomplish the activity. As another example, this may also include the display or activation of a reminder at a later scheduled time. As another example, this may also include the automatic activation of a product or service that corresponds to an identified tagged activity.

Further operations may be performed as a result of completion the method of flowchart 700. This may include the receipt of an indication of the performance of the subsequent action or activity (such as an indication that a follow-up has been performed to a customer), as shown in operation 760. In response to the detection or an indication of the performance, feedback for the action or activity may be recorded and analyzed, such as to determine whether the activity has been helpful or should be modified. The types of reminders and characteristics associated with the activity (and the tag) may be updated based on this feedback.

The rules, definitions, and stored data implemented in connection with the present dynamic interaction processing system may include any number of data sources (including external, or cloud-connected data services), and may be implemented in connection with a database management system, database, data service, or data store. The data representations and data flows discussed herein (such as in FIGS. 1 and 2) also may be implemented through the user of application programming interfaces (APIs) or other distributed interfaces that allow data processing and storage to occur among multiple locations.

Although many of the user interface examples included herein were discussed with reference to consultation settings in a customer/service provider scenario, it will be understood that other variations of the present techniques may be implemented for other types of person-to-person, company-to-person, and company-to-company interactions. Thus, the techniques discussed herein may be applicable for a variety of service industries including financial consultation, financial regulation, legal services, in addition to other forms of product sales settings.

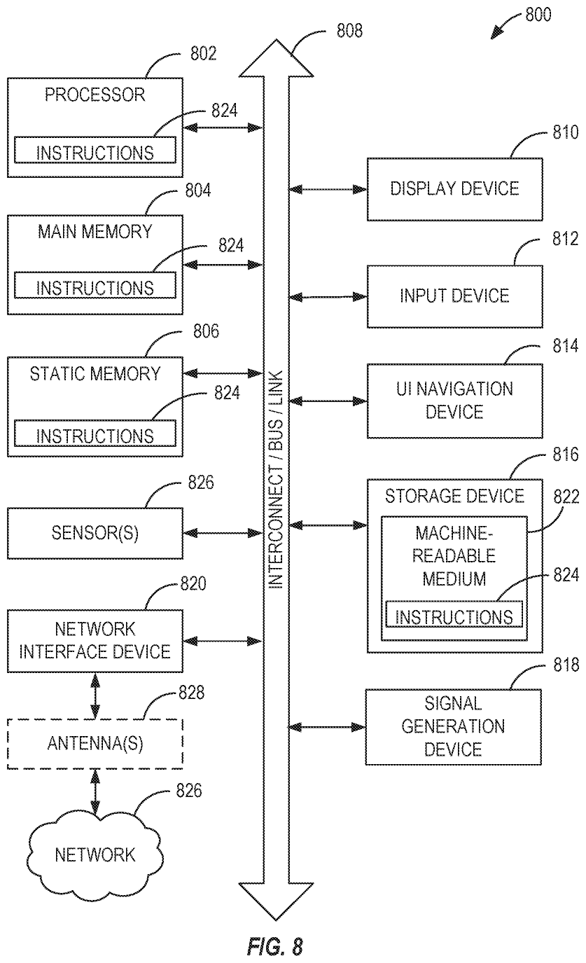

FIG. 8 illustrates a block diagram illustrating a machine in the example form of a computer system 800, within which a set or sequence of instructions may be executed to cause the machine to perform any one of the methodologies discussed herein for implementation of the electronic operations of a dynamic interaction processing system, according to an example. In an example, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments, The machine may be a personal computer (PC), a thin client, a tablet PC, a hybrid tablet, a set-top box (STB), a personal digital assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus or interconnect), The computer system 800 may further include a video display unit 810, an input device 812 (e.g., an alphanumeric keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, location sensor, or other sensor. For example, the features of the input device 812, the UI navigation device 814, and the video display unit 810, may be used to output and control the graphical user interfaces described above for the present dynamic interaction processing system.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). The communications with the communication network 826 optionally may occur using wireless transmissions sent via one or more antennas 828. Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any medium that is capable of storing, encoding, or carrying instructions for execution by the machine, and includes digital or analog communications signals or other mediums to facilitate communication of such software.

Moreover, the devices and subsystems of the present examples may communicate via one or more networks, which may include one or more of local-area networks (LAN), wide-area networks (WAN), wireless networks (e.g., IEEE 802.11 or cellular networks), the Public Switched Telephone Network (PSTN) network, ad hoc networks, cellular, personal area networks or peer-to-peer (e.g., Bluetooth®, Wi-Fi Direct), or other combinations or permutations of network protocols and network types. Thus, the processing components, communication devices, and interfaces which are provided with the dynamic interaction processing system may utilize any of these communication techniques.

The above description is intended to be illustrative, and not restrictive.

For example, the above-described examples (or one or more aspects thereof) may be used in combination with others. Other embodiments may be used, such as by one of ordinary skill in the art upon reviewing the above description. In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method for interfacing a computing system to a user to process textual data from a client interaction, the method comprising electronic operations performed by at least one processor and memory of a computing system, the electronic operations comprising:
providing a graphical user interface to the user, the graphical user interface comprising: a note description field; a note field; an interaction description field; and a tag field;
receiving, at the note description field, first textual data indicating a type of the client interaction, the client interaction being between the user and a human client;
receiving, at the note field, second textual data, wherein the second textual data includes free form text entered by the user in response to the client interaction, the free form text describing a topic of the interaction between the user and the human client, the topic expressing a sematic concept related to a future activity to be performed with a financial product or service;
receiving, at the interaction description field, interaction description data describing the client interaction;
selecting a tag type based at least in part on the first textual data and on client information describing the human client, the tag type indicating tags that are associated with a common concept;
selecting, from tags of the tag type, a set of tags for the topic, the selecting based at least in part on the second textual data and based at least in part on the interaction description data;
automatically displaying the set of tags at the tag field;
receiving, from the user via the graphical user interface, an indication of a custom tag describing the second textual data;
associating the second textual data with the set of tags and with the custom tag;
identifying a subsequent action based at least in part on the set of tags and based at least in part on the custom tag the subsequent action relating to a future interaction initiated by the user to offer the financial product or service to the human client, and wherein the subsequent action identifies an activity to be performed by the user that is associated with the human client and a time for performing the activity;
outputting an indication of the set of tags, an indication of the custom tag, and an indication of the subsequent action, the indication of the subsequent action indicating a future time for a reminder of the future activity to be performed with the financial product or service; and
receiving an indication of a performance of the subsequent action, the indication of the performance of the subsequent action comprising an evaluation of the subsequent action, the evaluation of the subsequent action indicating a rating of a success of the subsequent action.

2. The method of claim 1, wherein parsing the second textual data further includes:
identifying client information associated with the second textual data, wherein the client information is unique to the human client; and
wherein the client information associated with the second textual data is further used to identify the subsequent action to be performed.

3. (canceled)

4. The method of claim 1, the electronic operations further comprising matching a keyword selected from the second textual data to a first tag of the set of tags, wherein the selecting of the set of tags is based at least in part on the keyword.

5. (canceled)

6. The method of claim 1, the electronic operations further comprising:
parsing the second textual data to identify a second topic expressed in the second textual data, wherein the second topic is associated with a second tag;
associating the second textual data with the second tag, based on the second topic identified from the second textual data; and
wherein the subsequent action to be performed by the user is further identified based on the second tag.

7. The method of claim 1, the electronic operations further comprising:
storing the second textual data in a data store;
wherein the associating of the set of tags and the custom tag with the second textual data is established in the data store; and
wherein the set of tags and the custom tag are associated in the data store with a plurality of second textual data items for a plurality of human clients.

8. (canceled)

9. A non-transitory computer-readable storage medium, the computer-readable storage medium including instructions that when executed by a computer, cause the computer to perform electronic operations for interfacing the computer to a user, the electronic operations comprising:
providing a graphical user interface to the user, the graphical user interface comprising: a note description field; a note field; an interaction description field; and a tag field;
receiving, at the note description field, first textual data indicating a type of a client interaction, the client interaction being between the user and a human client, the topic expressing a sematic concept related to a future activity to be performed with a financial product or service;
receiving, at the note field, second textual data, wherein the second textual data includes free form text entered by the user in response to the client interaction, the free form text describing a topic of the client interaction;
receiving, at the interaction description field, interaction description data describing the client interaction;
selecting a tag type based at least in part on the first textual data and on client information describing the human client, the tag type indicating tags that are associated with a common concept;
selecting, from tags of the tag type, a set of tags for the topic, the selecting based at least in part on the second textual data, wherein the set of tags are of the tag type;
automatically displaying the set of tags at the tag field;
receiving, from the user via the graphical user interface, an indication of a custom tag describing the second textual data; associating the second textual data with the set of tags and with the custom tag;
identifying a subsequent action based at least in part on the set of tags and based at least in part on the custom tag, the subsequent action relating to a future interaction initiated by the user to offer the financial product or service to the human client, and wherein the subsequent action identifies an activity to be performed by the user that is associated with the human client and a time for performing the activity; outputting an indication of the set of tags, an indication of the custom tag, and an indication of the subsequent action to be performed, the indication of the subsequent action indicating a future time for a reminder of the future activity to be performed with the financial product or service; and
receiving an indication of a performance of the subsequent action, the indication of the performance of the subsequent action comprising an evaluation of the subsequent action, the evaluation of the subsequent action indicating a rating of a success of the subsequent action.

10. The computer-readable storage medium of claim 9, the electronic operations further comprising:
identifying client information associated with the second textual data, wherein the client information is unique to the human client; and
wherein the client information associated with the second textual data is further used to identify the subsequent action to be performed.

11. (canceled)

12. The computer-readable storage medium of claim 9, the electronic operations further comprising:
matching a keyword selected from the second textual data to a first tag of the set of tags, wherein the selecting of the set of tags is based at least in part on the keyword.

13. (canceled)

14. The computer-readable storage medium of claim 9, the electronic operations further comprise:
parsing the second textual data to identify a second topic expressed in the second textual data, wherein the second topic is associated with a second tag;
associating the second textual data with the second tag, based on the second topic identified from the second textual data; and
wherein the subsequent action to be performed by e user is further identified based on the second tag.

15. The computer-readable storage medium of claim 9, the electronic operations further comprise:
storing the second textual data and an association of the set of tags and the custom tag with the second textual data in a data store; and
wherein the set of tags and the custom tag are associated in the data store with a plurality of second textual data items for a plurality of human clients.

16. (canceled)

17. A computing system, comprising:
a processor; and
a memory device comprising instructions stored thereon, which when executed by the processor, configure the processor to perform electronic operations for interfacing the computing system to a user, the electronic operations comprising:
providing a graphical user interface to the user, the graphical user interface comprising: a note description field; a note field; an interaction description field; and a tag field;
receiving, at the note description field, first textual data indicating a type of a client interaction, the client interaction being between the user and a human client, the topic expressing a sematic concept related to a future activity to be performed with a financial product or service;
receiving second textual data at the note field, wherein the second textual data includes free form text entered by the user in response to the client interaction, the free form text describing a topic of the client interaction;
receiving, at the interaction description field, interaction description data describing the client interaction;
selecting a tag type based at least in part on the first textual data and on client information describing the human client, the tag type indicating tags that are associated with a common concept;
selecting, from tags of the tag type, a set of tags for the topic, the selecting based at least in part on the second textual data and based at least in part on the interaction description data, wherein the set of tags are of the tag type;
automatically displaying the set of tags at the tag field;
receiving, from the user via the graphical user interface, an indication of a custom tag describing the second textual data;
associating the second textual data with the set of tags and with the custom tag;
identifying a subsequent action based at least in part on the set of tags and based at least in part on the custom tag, the subsequent action relating to a future interaction initiated by the user to offer the financial product or service to the human client, and wherein the subsequent action identifies an activity to be performed by the user that is associated with the human client and a time for performing the activity;
outputting an indication of the set of tags, an indication of the custom tag, and an indication of the subsequent action, the indication of the subsequent action indicating a future time for a reminder of the future activity to be performed with the financial product or service; and
receiving an indication of a performance of the subsequent action the indication of the performance of the subsequent action comprising an evaluation of the subsequent action, the evaluation of the subsequent action indicating a rating of a success of the subsequent action.

18. The computing system of claim 17, further comprising:
storage hardware implementing a plurality of databases, the plurality of databases including a captured interaction database to store the second textual data and an association of the second textual data with the set of tags and the custom tag; and
wherein the set of tags and the custom tag is associated in the captured interaction database with a plurality of second textual data items for a plurality of human clients.

19. The computing system of claim 18, the memory device further comprising instructions stored thereon that, when executed by the processor, configure the processor to perform electronic operations further comprising:
identifying client information associated with the second textual data, wherein the client information is unique to a first human client of the plurality of human clients; and
wherein the client information associated with the second textual data is further used to identify the subsequent action to be performed.

20. (canceled)

21. The computing system of claim 17, the memory device further comprising instructions stored thereon that, when executed by the processor, configure the processor to perform electronic operations further comprising matching a keyword selected from the second textual data to a first tag of the set of tags, wherein the selecting of the set of tags is based at least in part on the keyword.

22. The computing system of claim 17, the memory device further comprising instructions stored thereon that, when executed by the processor, configure the processor to perform electronic operations further comprising:
parsing the second textual data to identify a second topic expressed in the second textual data, wherein the second topic is associated with a second tag;
associating the second textual data with the second tag, based on the second topic identified from the second textual data; and
wherein the subsequent action to be performed by the user is further identified based on the second tag.

23. The computing system of claim 17, the memory device further comprising instructions stored thereon that, when executed by the processor, configure the processor to perform electronic operations further comprising storing the second textual data in a data store, wherein the associating of the set of tags and the custom tag with the second textual data is established in the data store, and wherein the set of tags and the custom tag are associated in the data store with a plurality of second textual data items for a plurality of human clients.
